(19) United States
(12) Patent Application Publication
(10) Pub. No.: US 2007/0152423 A1
(43) Pub. Date: Jul. 5, 2007

(54) Pivoting belt or chain guard

(75) Inventor: Scott Waters, Arlington, TX (US)

Correspondence Address: VENABLE LLP, P.O. BOX 34385, WASHINGTON, DC, 20043-9998, US

(73) Assignee: American IronHorse Motorcycle Company, Ft. Worth, TX (US)

(21) Appl. No.: 11/638,353

(22) Filed: Dec. 14, 2006

Related U.S. Application Data
(60) Provisional application No. 60/750,387, filed on Dec. 15, 2005.

(51) Int. Cl. B62J 27/00

(52) U.S. Cl. 280/304.3

(57) ABSTRACT

A guard is provided for use with a flexible drive coupling of a vehicle having a swingarm-type suspension, the flexible drive coupling being for coupling a transmission output sprocket to a wheel sprocket. The guard has a drive coupling guard portion; a pivoting end; a wheel end; a wheel end attachment portion for attaching the wheel end of the guard to the vehicle at a first attachment point; and a pivoting end attachment portion for attaching the pivoting end of the guard to the vehicle at a second attachment point such that the guard is pivotable about the second attachment point.

### BACKGROUND OF THE INVENTION

This application claims the benefit of U.S. Provisional Patent Application No. 60/750,387 filed Dec. 15, 2005, which is incorporated in its entirety herein by reference.

The invention relates to a guard for a belt or a chain. More particularly, the invention relates to a guard for a drive belt or a drive chain for a motorcycle.

### ARY OF THE INVENTION

An embodiment of the invention provides a guard for use with a flexible drive coupling of a vehicle having a swingarm -type suspension, the flexible drive coupling being for coupling a transmission output sprocket to a wheel sprocket. The guard has a drive coupling guard portion; a pivoting end; a wheel end; a wheel end attachment portion for attaching the wheel end of the guard to the vehicle at a first attachment point; and a pivoting end attachment portion for attaching the pivoting end of the guard to the vehicle at a second attachment point such that the guard is pivotable about the second attachment point.

### BRIEF DESCRIPTION OF THE DRAWINGS

Further advantages and details of the invention follow from the exemplary embodiments and are explained in the following with the aid of the Figure, in which:

FIG. 1 is an exploded view of an example of a guard assembly in accordance with the invention;

FIG. 2 is an exploded view of a portion of the guard assembly shown in FIG. 1;

FIG. 3 is a perspective view of the portion shown in FIG. 2;

FIG. 4 is a side view of the portion shown in FIG. 2;

FIG. 5 is a perspective view of a shoulder washer in accordance with the invention;

FIG. 6 is a front view of the shoulder washer shown in FIG. 5;

FIG. 7 is a sectional view along section line VII-VII in FIG. 6;

FIG. 8 is a perspective view of a wave spring washer in accordance with the invention;

FIG. 9 is a side view of the wave spring washer shown in FIG. 8;

FIG. 10 is a front view of the wave spring washer shown in FIG. 8;

FIG. 11 is a perspective view of a retaining cap in accordance with the invention;

FIG. 12 is a rear view of the retaining cap shown in FIG. 11;

FIG. 13 is a front view of the retaining cap shown in FIG. 11;

FIG. 14 is a sectional view along section line XIV-XIV in FIG. 13;

FIG. 15 is a perspective view of a shoulder washer in accordance with the invention;

FIG. 16 is a rear view of the shoulder washer shown in FIG. 15;

FIG. 17 is a front view of the shoulder washer shown in FIG. 15;

FIG. 18 is a sectional view along section line XVIII-XVIII in FIG. 17;

FIG. 19 is a perspective view of a wave spring washer in accordance with the invention;

FIG. 20 is a side view of the wave spring washer shown in FIG. 19;

FIG. 21 is a front view of the wave spring washer shown in FIG. 19;

FIG. 22 is a perspective view of a spacer in accordance with the invention;

FIG. 23 is a rear view of the spacer shown in FIG. 22;

FIG. 24 is a front view of the spacer shown in FIG. 22; and

FIG. 25 is a sectional view along section line XXV-XXV in FIG. 24.

### DETAILED DESCRIPTION OF THE INVENTION

The invention will be described using the example of a belt guard for use on a motorcycle having a drive belt that connects an output shaft of the motorcycle's transmission to the rear wheel of the motorcycle.

In this example, the pivoting feature of the guard allows the guard assembly to be one piece and also tightly follow the chain or belt. Non-pivoting guards are made of two detached pieces (one being attached to the swing arm and the other being attached to the frame) and/or are positioned to allow for movement of the swing arm such that the guard does not hit the chain or belt.

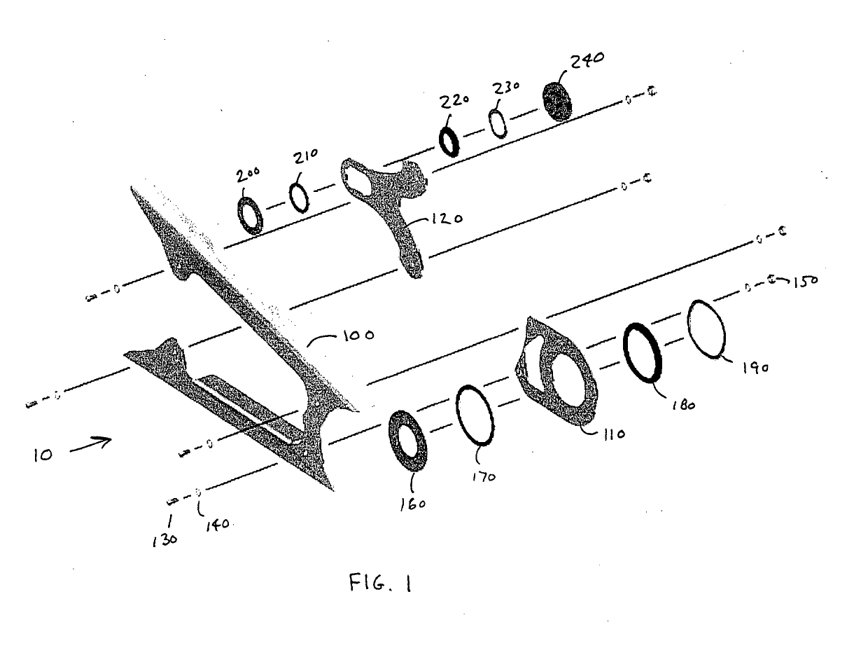

The example shown in FIG. 1 is pivotably attached to a transmission at one end and is attached to the motorcycle at its other end by way of a slot. The slot receives the rear wheel axle or some extension of the axle. It may be advantageous to provide a bushing that rotates freely about the axle so that the slot does not directly contact the axle or any other part that rotates with the axle. By providing such a bushing (or some other similar element), friction between the axle and the slot can be greatly reduced.

While the example shown in the figures has a particular shape, it is noted that any other appropriate shape can be used. Also, while it may be preferable to include guard portions that cover the top, bottom and side of the belt or chain, some embodiments cover only the side of the belt or chain. Still other embodiments cover only the top of the belt or chain, or only the top and bottom of the belt or chain (realizing that some support structure may be needed that covers a small portion of the side of the belt or chain). The pivoting and sliding nature of the invention permits shapes that are not available with a non-pivoting guard. In addition, the invention permits smaller, more visually attractive guards because it is not necessary to allow for vertical movement of the belt or chain relative to the guard.

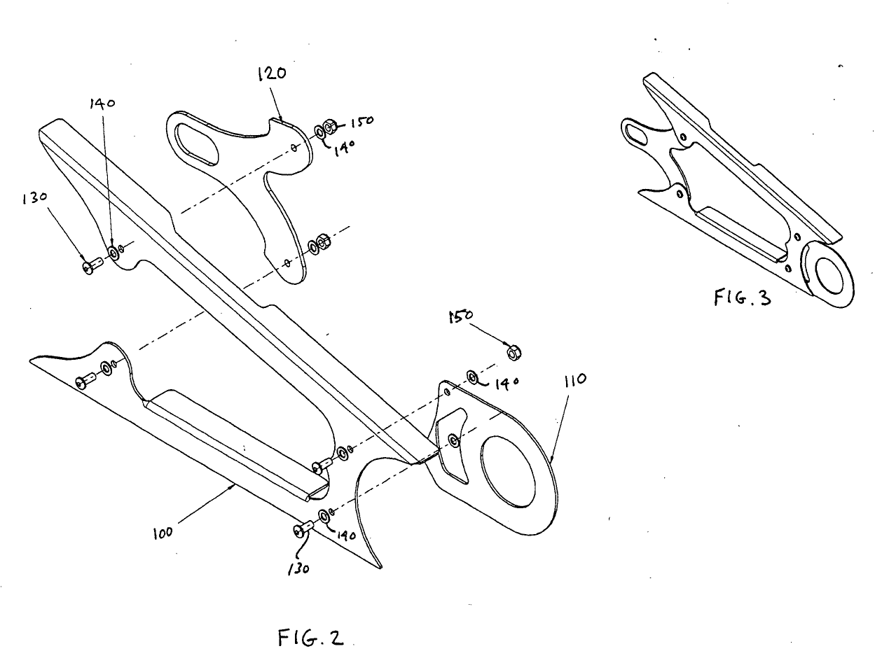

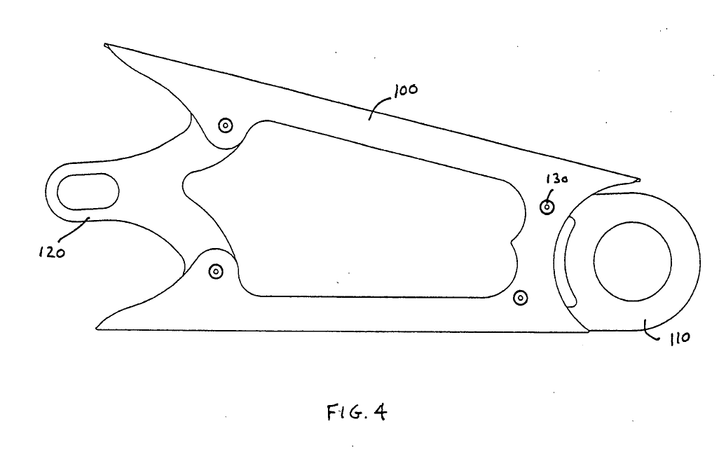

FIG. 1 is an exploded view of a guard assembly 10 which is an example of an embodiment of the invention. Guard assembly 10 has, in this example, three main components, a shield 100, a transmission mount 110, and an axle mount 120. FIGS. 2 and 3 show that shield 100, transmission mount 110 and axle mount 120 are bolted together using bolts 130, washers 140, and nuts 150 to form one rigid assembly. FIG. 3 is a perspective view, and FIG. 4 is a side view, of shield 100, transmission mount 110, and axle mount 120 in the assembled state. The slot shown in axle mount 120 allows for movement between the wheel axle and mount 120. This movement may be necessary when the suspension is compressed (or extended) while the motorcycle is being ridden and/or when the rear axle position is adjusted to tighten or loosen the belt (or chain).

Although other embodiments of the invention provide a shield, a transmission mount, and an axle mount in one piece, providing three separate pieces as shown in FIGS. 1-4 allows shield 100 to be removed from the motorcycle without having to remove the rear wheel, axle, swingarm or any other piece. This can be advantageous if, for example, shield 100 is damaged and needs to be replaced, or if shield 100 is to be removed for some other reason. In particular applications, this removability of shield 100 can allow the drive belt to be removed from the motorcycle without requiring removal of the rear wheel. In addition, having transmission mount 110 and axle mount 120 being separate pieces from shield 100 allows different shaped shields 100 to be used. This is advantageous when, for example, a motorcycle owner wants to customize his or her motorcycle by using a different shield 100, but does not want to suffer the expense of purchasing an entire new guard assembly.

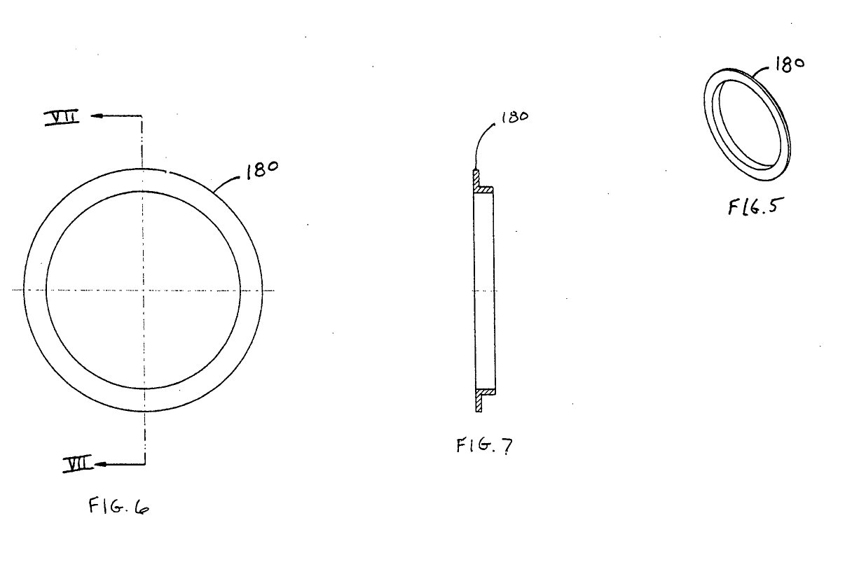

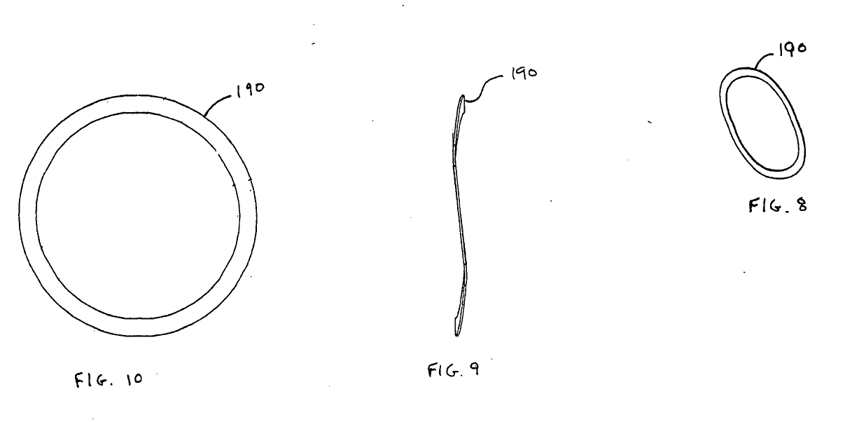

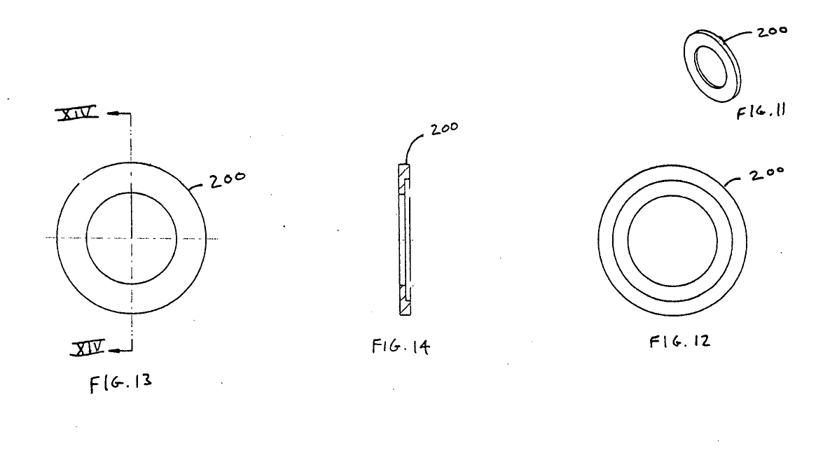

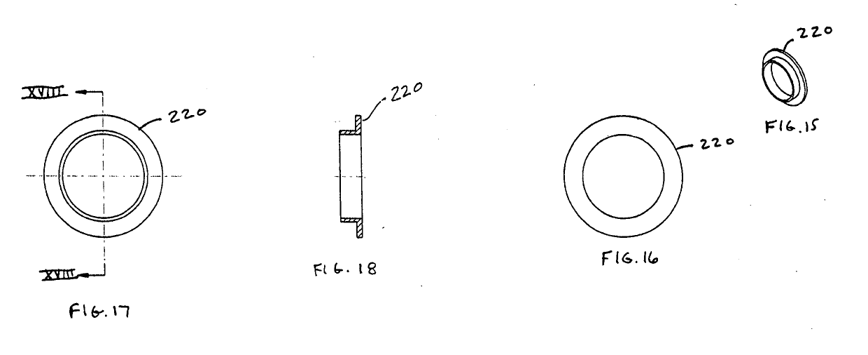

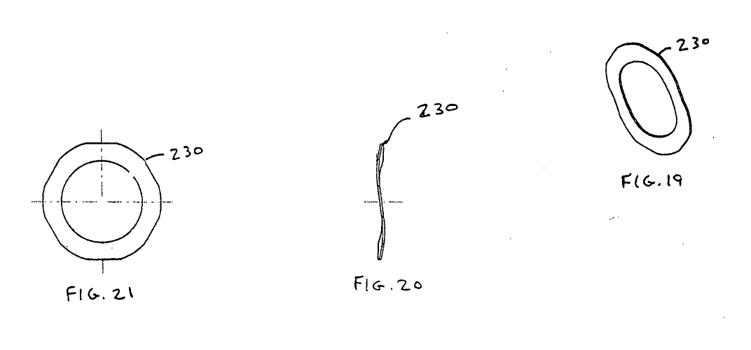

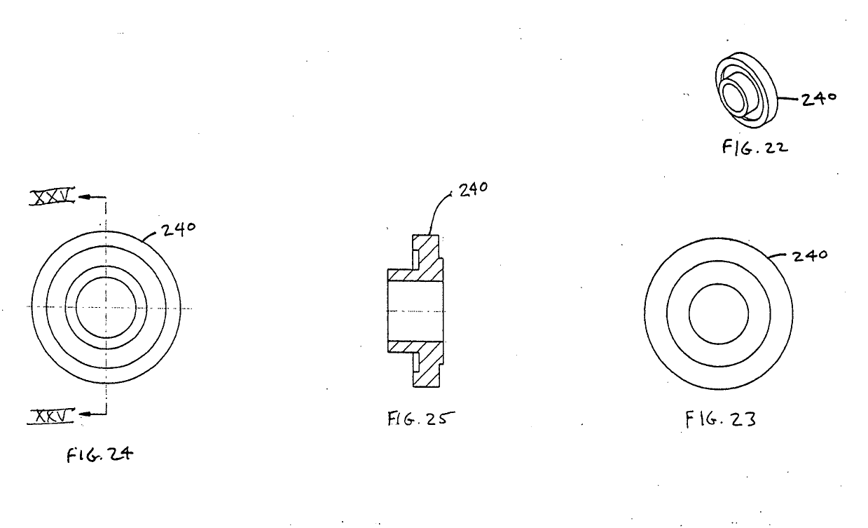

FIG. 1 shows additional components that can be used to attach transmission mount 110 to the transmission of the motorcycle. In this example, these additional components include a retaining cap 160, a retaining washer 170, a shoulder washer 180, and a wave spring washer 190. In this example, retaining cap 160 is a flat washer-like disc and retaining washer 170 is a flat washer. FIGS. 5-7 show in more detail an example of shoulder washer 180. FIGS. 8-10 show in more detail an example of wave spring washer 190. FIG. 1 also shows additional components that are used, in this example, to attach axle mount 120 to the rear axle of the motorcycle. These additional components include a retaining cap 200, a retaining washer 210, a shoulder washer 220, a wave spring washer 230, and a spacer 240. FIGS. 11-14 show in more detail an example of retaining cap 200. Retaining washer 210 is a flat washer. FIGS. 15-18 show in more detail an example of shoulder washer 220. FIGS. 19-21 show in more detail an example of wave spring washer 230. FIGS. 22-25 show in more detail an example of spacer 240. Spacer 240 slides over the rear wheel axle of the motorcycle and acts as a bearing between shoulder washer 220 and the rear wheel axle. By providing lateral pressure on the components, wave washers 190, 230 keep the components together to act as bearings for mounts 110, 120.

The components shown in FIG. 1 are just one example of how transmission mount 110 and axle mount 120 can be attached to the motorcycle. Other attachment systems can be used as long as they allow transmission mount 110 to rotate relative to the transmission and allow axle mount 120 to rotate and slide relative to the rear wheel axle.

It is also noted that while the invention has been described as applied to a motorcycle having a swing-arm type suspension, the invention can also be applied to other suspension configurations that allow for movement of a wheel relative to at least one of the mounting points of the guard. The invention is also applicable to vehicles with three or more wheels.

The invention is not limited to the above-described exemplary embodiments. It will be apparent, based on this disclosure, to one of ordinary skill in the art that many changes and modifications can be made to the invention without departing from the spirit and scope thereof.

What is claimed is:

1. A guard for use with a flexible drive coupling of a vehicle having a swingarm-type suspension, the flexible drive coupling being for coupling a transmission output sprocket to a wheel sprocket, the guard comprising:
a drive coupling guard portion;
a pivoting end;
a wheel end;
a wheel end attachment portion for attaching the wheel end of the guard to the vehicle at a first attachment point; and
a pivoting end attachment portion for attaching the pivoting end of the guard to the vehicle at a second attachment point such that the guard is pivotable about the second attachment point.

2. The guard of claim 1, wherein the wheel end attachment portion has a slot for receiving the first attachment point.

3. The guard of claim 2, wherein the slot is for receiving a wheel axle of the motorcycle.

4. The guard of claim 3, wherein the pivoting end is for attaching to a transmission of the vehicle such that the guard can rotate relative to the transmission of the vehicle.

5. The guard of claim 4, wherein the pivoting end further comprises a shoulder washer for attaching the guard to the transmission of the vehicle.

6. The guard of claim 5, wherein the slot is for allowing the wheel end attachment portion to move linearly relative to the wheel axle.

7. The guard of claim 6, wherein the slot is for allowing the wheel end attachment portion to rotate relative to the wheel axle.

8. The guard of claim 7, wherein the drive coupling guard portion is detachable from the wheel attachment portion and the pivoting attachment portion.

9. The guard of claim 8, wherein the drive coupling guard portion is adapted to be detachable from the wheel attachment portion and the pivoting attachment portion when the wheel attachment portion and the pivoting attachment portion are attached to the vehicle, and
the drive coupling guard portion is adapted to be removable from the vehicle when the wheel attachment portion and the pivoting attachment portion remain attached to the vehicle.

10. The guard of claim 9, further comprising a second drive coupling guard portion that is substantially perpendicular to the drive coupling guard portion.

11. The guard of claim 3, wherein the slot is for allowing the wheel end attachment portion to move linearly relative to the wheel axle.

12. The guard of claim 11, wherein the slot is for allowing the wheel end attachment portion to rotate relative to the wheel axle.

13. The guard of claim 12, wherein the drive coupling guard portion is detachable from the wheel attachment portion and the pivoting attachment portion.

14. The guard of claim 13, wherein the drive coupling guard portion is adapted to be detachable from the wheel attachment portion and the pivoting attachment portion when the wheel attachment portion and the pivoting attachment portion are attached to the vehicle, and
the drive coupling guard portion is adapted to be removable from the vehicle when the wheel attachment portion and the pivoting attachment portion remain attached to the vehicle.

15. The guard of claim 14, further comprising a second drive coupling guard portion that is substantially perpendicular to the drive coupling guard portion.

16. The guard of claim 1, wherein the vehicle is a motorcycle and the first attachment point is a rear wheel axle of the motorcycle.

17. The guard of claim 16, wherein the flexible drive coupling is a belt that attaches the transmission sprocket of the motorcycle to the wheel sprocket of the motorcycle.

18. The guard of claim 16, wherein the flexible drive coupling is a chain that attaches the transmission sprocket of the motorcycle to the wheel sprocket of the motorcycle.
